(19) United States
(12) Patent Application Publication
(10) Pub. No.: US 2009/0033671 A1
(43) Pub. Date: Feb. 5, 2009

(54) MULTI-SAMPLE RENDERING OF 2D VECTOR IMAGES

(75) Inventors: Mika Tuomi, Noormarkku (FI); Kiia Kallio, Inkoo (FI); Jarno Paananen, Tampere (FI)

Correspondence Address: ADVANCED MICRO DEVICES, INC.;C/O VEDDER PRICE P.C., 222 N.LASALLE STREET, CHICAGO, IL, 60601, US

(73) Assignee: ATI Technologies ULC, Markham (CA)

(21) Appl. No.: 11/832,773

(22) Filed: Aug. 2, 2007

(51) Int. Cl. G09G 5/36

(52) U.S. Cl. 345/545

(57) ABSTRACT

A method and device for enhanced rendering providing reduced memory bandwidth requirements in a graphics processor. In the rendering process, a classification buffer of limited bit length is used for classifying the pixels. Based on the classification, a decision on the pixel color may be made without accessing the multi-sample buffer for a portion of the pixels. This reduces the memory bandwidth requirements.

### FIELD OF THE INVENTION

The invention relates to vector graphics and particularly to an efficient method and device for rendering two-dimensional vector images.

### BACKGROUND OF THE INVENTION

Recently handheld devices have been enabled with multimedia capabilities. Since the introduction of the first multimedia-capable handheld device, the functionality of the devices has increased enormously. Thus, modern handheld devices, such as mobile phones or other handheld multimedia computers have been enabled with decent color graphics, cameras, music players and fast communication capabilities. However, new features are still being introduced, and the already existing features are continually improved in order to provide an improved user experience.

The graphics capabilities are commonly improved by using anti-aliasing. There are basically two variants of anti-aliasing in use with 2D vector graphics: edge anti-aliasing and full-scene anti-aliasing.

In edge anti-aliasing, the anti-aliasing is performed at polygon edges during rasterization, the polygon coverage is converted to transparency, and the polygon paint color is blended on the target canvas using this transparency value. Although the specification does not dictate this explicitly, edge anti-aliasing is the assumed rendering model of Open VG 1.0 API.

In full-scene anti-aliasing, a number of samples are stored per pixel, and the final pixel color is resolved in a separate pass once the image is finished. This is the typical method for anti-aliased rendering of 3D graphics. Also Adobe Flash uses the full-scene approach for 2D vector graphic rendering.

A problem with edge anti-aliasing is that it can create rendering artifacts, for instance at adjacent polygon edges. For example, Adobe Flash content cannot be rendered properly using edge anti-aliasing. On the other hand, the typical full-scene anti-aliasing methods require a high amount of memory and use an excessive amount of bandwidth.

Perfect anti-aliasing requires calculation of the coverage of all contributing geometry within a pixel, and resolving of the final pixel color from this information. In practice, an analytical solution to this requires clipping of polygon fragments at the pixel level. However, since such algorithms are not practical, considering the detrimental impact on the performance, the typical 2D rendering APIs render the polygons one by one and accept the resulting artifacts when seeking a balance of performance and quality.

In order to avoid these artifacts, some architectures use work-around techniques, such as compound shapes. A compound shape is a collection of polygon edges that defines a set of adjacent polygons. A compound shape rasterizer can then evaluate the total coverage and color of all polygons for each pixel with relatively straightforward software implementation. However, because of the limitations of compound shapes, this method is not very general and requires specifically prepared data where overlap is removed in order to produce expected or desired results.

A relatively straightforward approach for avoiding these artifacts is just to use super-sampling or multi-sampling techniques. This has the benefit of the conventional rendering model regarding the blending operations and transparency, i.e. data is processed in a back-to-front order, but often memory and bandwidth consumption can be problematic.

In its most basic form, super-sampling uses a rendering buffer with higher resolution and scales it down during the resolve pass, averaging the pixel value from all samples within the pixel area. Multi-sampling, on the other hand, is a bit more advanced method. In multi-sampling, the data assigned to a pixel consists of a single color value and a mask indicating to which samples within a pixel the color is assigned.

Thus, there is a need for an improved and more cost-effective rendering mechanism with appropriate anti-aliasing capability.

### SUMMARY

Embodiments of the invention disclose a method and device for enhanced rendering providing reduced memory bandwidth requirements in a graphics processor. During rendering, a classification process is performed on the pixels. Based on the classification, a decision of the pixel color may be calculated without accessing a multi-sample buffer for a portion of the pixels. This reduces the memory bandwidth requirements.

In an embodiment of the invention, the method for rendering vector graphics image comprises clearing the classification buffer, rendering the polygons using the multi-sample buffer and the classification buffer, resolving the pixel values and producing an image in the target image buffer. Pixel classification is based on the coverage value of each pixel. The pixel classification typically comprises four different classes that can be represented by two bits. Typically, the classes are background, unexpanded, compressed and expanded. In the compressed class, the coverage mask of the pixel is compressed using a lossless compression method.

In an embodiment of the invention, clearing of the classification buffer is performed by setting all pixels in said classification buffer as background. A benefit of clearing the classification buffer is that it speeds up clearing of the image as there is no need to write to pixel colors at clearing stage. The pixel values are resolved using said classification and multi-sample buffers. It is possible to perform intermediate solving at any stage of the rendering.

In a further embodiment, the rendering of the vector graphics image is performed in tiles. In this embodiment, the multi-sample buffer size may be reduced.

In one embodiment, the present invention is implemented in a graphics processor, wherein the graphics processor comprises a classification buffer, a multi-sample buffer and a target image buffer. The processor further comprises processing means that are capable of executing input commands representing the vector image. The graphics processor may also contain additional memory for alternative embodiments of the present invention. In addition to the present invention, the graphics processor includes a plurality of graphics-producing units that are required for the functionality that is needed for producing high quality graphics.

The present invention provides an efficient vector graphics rendering method for devices having low memory bandwidth. This enables high quality graphics production with lower computing power cost than the prior art systems. Thus, it is suitable and beneficial for any device using computer graphics. These devices include for example mobile phones, handheld computers, ordinary computers and alike.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention.

In the drawings:

FIG. 1 is a block diagram of an example embodiment of the present invention,

FIG. 2 is a flow chart of an example method according to the present invention,

FIG. 3 is a flow chart of an example method according to the present invention,

FIG. 4 is a flow chart of an example method according to the present invention,

FIG. 5a is a flow chart of an example method according to the present invention

FIG. 5b is a flow chart of an example method according to the present invention,

FIG. 5c is a flow chart of an example method according to the present invention.

### DETAILED DESCRIPTION OF THE INVENTION

Detailed reference will now be made to the embodiments of the present invention, examples of which are illustrated in the accompanying drawings.

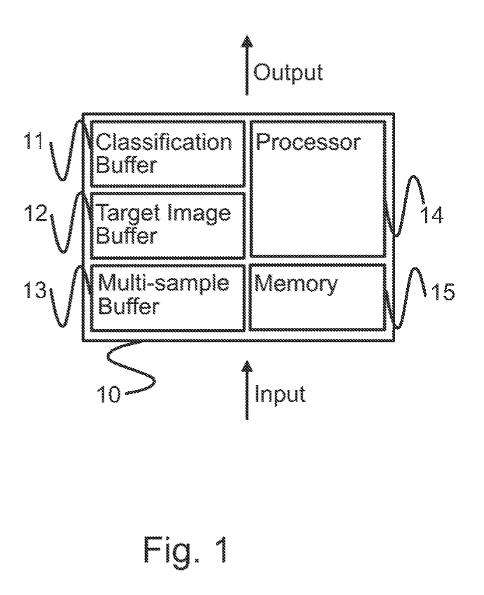

FIG. 1 is a block diagram of an example embodiment of the present invention. The present invention is designed to be completely implemented in a graphics processor and therefore the examples relate to such an environment. However, a person skilled in the art recognizes that some portions of the present invention can be implemented as a software component or in other hardware components than a graphics processor. FIG. 1 discloses an example block 10. The block 10 includes a processor 14, a classification buffer 11, a target image buffer 12 and a multi-sample buffer 13. The processor 14 is typically shared with other functionality of the graphics processing unit included in block 10. Each of the buffers 11-13 may have a reserved portion of the memory implemented in the graphics processing unit including the block 10. Thus, the memory is shared with other functionality of the graphics processing unit. However, typically the portions allocated for the buffers 11-13 are dedicated for them. Thus, the memory may be exclusively reserved for the relevant functionality described herein. FIG. 1 also discloses an additional memory 15 that is reserved for further needs and for running applications in the processor 14. This memory may be inside the block 10, outside the block 10 but inside the graphics processor, or the memory 15 may be an external memory. The input and output data formats may be selected according to the requirements disclosed herein as will be appreciated by one of ordinary skill in the art.

For a better understanding of the invention, it must be noted that the present embodiments uses pixels that are further divided into sub-pixels for computing the coverage value of the pixel in cases where an edge of a polygon covers the pixel only partially. For example, a pixel can be divided into a set of 16*16 sub-pixels. Representative samples (e.g., 16 samples) are then chosen from the set of sub-pixels. The samples are chosen so that they represent the coverage of the pixel well. This can be achieved, for example, by choosing randomly 16 samples that each have unique x and y values from the set of pixels. However, even if 16 samples and a set of 16*16 sub-pixels are illustrated here, the present invention is not limited to this. A person having ordinary skill in the art recognizes that also a different number of samples and different sets of sub-pixels may be used. For example, 8 or 32 samples. Typically 16 samples are used with a set of 16*16 sub-pixels and correspondingly 32 samples are used with a set of 32*32 sub-pixels and so on. However, this is not necessary and it is possible to use, for example, 32 samples with a set of 16*16 sub-pixels.

The example embodiment of the present invention includes a classification buffer 11 which, in the exemplary embodiment, stores 2 bit classification values or codes. The dimensions of the classification buffer 11 correspond to the size of the target image buffer 12 so that each pixel of the target image buffer 12 has corresponding classification bits in the classification buffer 11. In addition, a multi-sample image buffer 13 is used for storing both compressed and expanded pixel data. For 16 samples, this needs to be 16 times the size of the target image buffer 12. It is noted that if the operating environment supports dynamical memory allocation, the memory required by the multi-sample buffer 13 may be reduced. In static implementations, such as hardware implementations, the multi-sample buffer 13 should be allocated memory according to the worst case scenario without any compression.

The compression method according to the present embodiment will now be described in more detail. The compression method of the present embodiment relies on the fact that the pixels of the image can be classified into three different categories: unaffected pixels that are pixels with background color, pixels completely inside the rendered polygon and pixels at the polygon edges. The vast majority of the pixels at the polygon edges involve only one of the two colors, which are the background color for unaffected pixels and the polygon paint color for pixels completely inside the rendered polygon. This allows the representation of those pixels with one 16-bit mask and two color values.

The compression method takes advantage of the aforementioned concepts and divides the pixels in four categories:
Background pixels—no color value is stored for these
Unexpanded pixels—the color value is stored in the target image buffer
Compressed pixels—the color value is stored as compressed data in a temporary multi-sample buffer
Expanded pixels—the color value is stored as individual samples in a temporary multi-sample buffer

Each of these four categories is assigned a corresponding two-bit value in the classification buffer. It is worth noting that the compression of the example embodiment is lossless and only based on the coverage masks of the pixels, and color values are not analyzed. This makes the implementation of the compression method very efficient. However, it is possible to use also other compression methods that may be lossy or lossless.

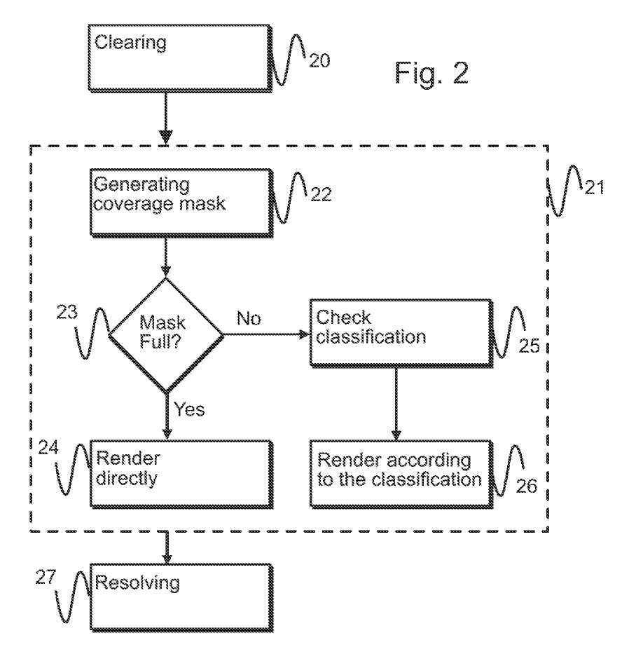

FIG. 2 discloses a flow chart of the rendering method according to an example embodiment. The rendering process consists of three phases: clearing 20, polygon processing 21, and resolving 27. These three steps are independent and, in the exemplary embodiments described herein, repeated in this order to generate finished frames. Polygon processing further comprises steps 22-26. Typically all polygons are processed before moving into resolving step 27. As described below, other ordering of these steps is possible. However, it is also possible to perform intermediate resolving to provide the image at any given point during the rendering, as the resolve step affects only unused pixels in the target image buffer. A person skilled in the art recognizes that these steps may be processed concurrently to compute a plurality of frames at the same time. However, in order to provide a better understanding of the present invention, sequential processing of a single frame will be disclosed in the following.

First, a clear operation is issued, step 20. This involves only marking all pixels in the classification buffer as background pixels and storing the background color value. No pixel colors are modified in the target image buffer or in the multi-sample buffer. This is typically beneficial as clearing the classification buffer speeds up clearing of the image. This is typically faster than writing pixel colors at the clearing stage. However, in an alternative implementation clearing may be implemented without background classification by writing constant color value over the image. In the alternative implementation the pixels would be classified as unexpanded and color value would be written into the target image buffer.

After this, the polygons are processed one polygon at a time, step 21. Each polygon has a paint color. Often this is constant throughout the polygon, but may change per pixel and also especially if gradients or textures are used. The paint color can also have translucency defined as an alpha value. Polygons may be rendered with some blending, but for simplicity we will first explain the case of opaque paint and no blending.

A 16-bit coverage mask is generated for each pixel of the polygons, step 22. The coverage mask contains those samples within the pixel that are inside the polygon, depending on the shape of the polygon and the fill rule used for determining the “insideness”. This can be determined either in scanline order or using a tiling rasterizer, for instance a rasterizer which does this in 64×64 blocks of pixels. The size of the coverage mask can be chosen according to the application. For example, if eight samples per pixel are preferred, then only eight bits are needed.

If the coverage mask for a pixel is full, step 23, i.e. all 16 bits are set, it will be rendered directly in the target image buffer and the value for the pixel in the classification buffer is set as “unexpanded”, step 24. This operation may also convert multi-sampled pixels back to unexpanded format, since the new opaque color value will discard anything that has already been stored for that pixel.

However, if the coverage is partial, the classification of the target pixel needs to be taken into account, step 25, before rendering, step 26. A compressed entry is created in the multi-sample buffer for background pixels and unexpanded pixels, wherein the mask is the generated coverage mask and the first color entry is either set as the background color or as the color in the target image buffer, and the second entry is set as the current paint color. Also, the classification value for the pixel is set as “compressed”.

For compressed pixels, it is possible that the pixel stays compressed, in which case one of the color entries is changed into the current paint color and the mask is possibly updated. This can be detected by checking if the new coverage mask fully covers either part of the stored coverage mask. If this isn't the case, i.e. both already stored colors remain visible when the new mask is applied, the data will be expanded to full 16 samples and the classification value for the pixel will be set as “expanded”. If the stored pixel is already in the expanded form, the pixel values will just be stored in appropriate sample positions in the multi-sample buffer.

For blended values, depending on the alpha component of the paint color and on the blend mode used, the target pixels must always be taken into account. If the blended pixel has full coverage, it will just be blended with all relevant color values in the target image buffer. If the coverage is partial, the blending needs to be performed with appropriate components of the target pixel, depending on the pixel classification. Typically, classification of the pixel is converted to another classification when the polygon is rasterized in the same location. The various conversions are listed in table 1.

TABLE 1
Classification Conversion Table

| | Background | Unexpanded | Compressed | Expanded |
|---|---|---|---|---|
| Full coverage | Unexpanded | Unexpanded | Unexpanded with | Unexpanded with |
| opaque | with paint | with paint | paint color | paint color |
| | color | color | | |
| Partial | Compressed | Compressed | Compressed or | Expanded, paint |
| coverage | with | with old | expanded. If the | color replaces the |
| opaque | background | unexpanded | coverage mask fully | samples in the |
| | and paint | color and | covers either half of | multi-sample |
| | colors | paint color | the stored mask, the | buffer based on the |
| | | | paint will replace the | coverage mask. |
| | | | relevant stored | |
| | | | color. Otherwise | |
| | | | convert to expanded. | |
| Full coverage | Unexpanded, | Unexpanded, | Compressed, blend | Expanded, blend |
| blended | blend | blend | paint color with both | paint colour with |
| | paint color | paint color | stored colors | all sample colors |
| | with | with | | |
| | background | existing | | |
| | color | unexpanded | | |
| | | color | | |
| Partial | Compressed | Compressed | Compressed or | Expanded, blend |
| coverage | with | with old | expanded. If the | paint colour with |
| blended | background | unexpanded | coverage mask | samples in the |
| | color and the | color and the | matches exactly the | multi-sample |
| | color blended | color blended | stored mask or its | buffer based on the |
| | of the | of the old | inverse, the paint | coverage mask. |
| | background | unexpanded | will be blended with | |
| | color and the | color and the | the relevant stored | |
| | paint color | paint color | colour. Otherwise | |
| | | | convert to expanded | |
| | | | and blend the paint | |
| | | | with appropriate | |
| | | | samples. | |

The last step in the image generation is the resolve pass, step 27. This step involves reading the values from the classification buffer, and writing appropriate color to the target image buffer according to the classification. Background classification is written with the background color to the target image buffer. Unexpanded classification is ignored as the target color is already there. Compressed classification converts the coverage mask to coverage percentage, blends the stored two colors together and writes them to the target image buffer. Expanded classification calculates the average of all stored sample values and writes them to the target image buffer. At this stage, the image is completed in the target image buffer.

The method explained above assumes a single multi-sample buffer. However, for large screen resolutions, this buffer may consume tens of megabytes of memory. Therefore, alternative approaches are required for hand-held devices.

Typically, only a very small portion of the pixels in the image require a fully expanded multi-sample buffer. However, in the worst case scenario, it may be used by every pixel in the image. Since the usage is unknown until the image becomes rendered, the implementation that allocates just the right amount required for rendering needs to perform dynamic memory allocation during rasterization. In hardware implementation, this is not feasible.

In an example embodiment of the present invention, rasterization is done in tiles of 64×64 in a desired order, such as from left to right and from top to bottom. These tiles are not really screen tiles, but temporary tiles used by the rasterizer. This is a fairly efficient mechanism, and allows rasterization in constant memory space without using list structures for polygon edges. This mechanism, however, requires that polygons larger than 64×64 pixels be processed multiple times, once per each rasterization tile.

Since this mechanism already splits the polygons in tiles, the tiling can be extended to include the multi-sampling process as well. Instead of rendering one polygon at a time in the tile order, all polygons that fall into a single tile are rendered using the multi-sample buffer matching the tile size, and the final output of the tile is resolved in the target image buffer. This approach requires full capture of the whole input data, as the same input data needs to be processed multiple times. Since the path data is already stored as separate buffers in the input, this means, in practice, only recording the command stream, which is relatively lightweight (from a memory consumption viewpoint).

There is no additional processing overhead involved regarding the tiling, as the tiles for all polygons need to be resolved anyway.

Furthermore, there is no significant dependency between the rasterization tile size and the multi-sample buffer size; the multi-sample buffer just should be large enough to hold at least one rasterization tile at a time. Larger multi-sample buffers can provide better performance, for instance by using the width of the target image buffer as the tile width. This way there is no need for per-tile edge clamping operations; instead the rasterization process can utilize the typewriter scanning order of the tile rasterizer and inherit information from the tile on the left while proceeding forward to the right. The data sizes can even still be relatively large, for instance a 640×64 multi-sampling buffer would consume 2.5 megabytes of memory. Since the amount of memory depends on the rasterization tile height and the target image buffer width, changing the aspect ratio of the rasterization tile, for instance to 32×128, can considerably reduce the size of the multi-sample buffer. Typically, it can be considered feasible if the multi-sampling buffer consumes 1-2 times the memory consumed by the target bitmap. A rasterization tile size of 32×128 with VGA screen (640×480) would result in a buffer with dimensions of 640×32-consuming only a few percent more than the screen itself.

If the size of the multi-sample buffer is reduced this way, also the classification buffer will become smaller. To gain further savings with bandwidth usage and latency, it is possible to store this buffer in an on-chip memory.

In order to accelerate clearing of the classification buffer, it is possible to build yet another hierarchy level on top of it, storing one bit for a group of pixels (for instance 32 pixels) that indicates that all pixels in the group are classified as background. This reduces the amount of read accesses to the classification buffer and also reduces the size of the initial clear operation.

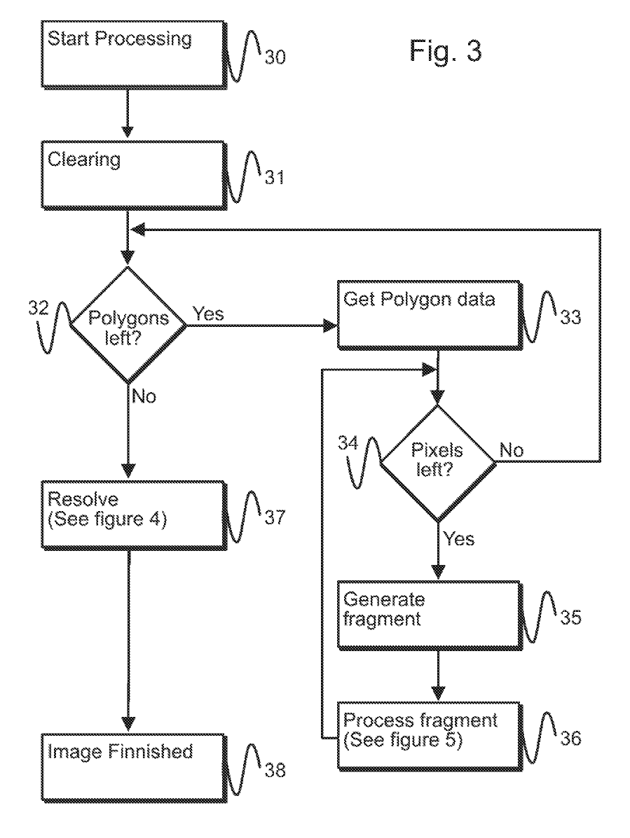

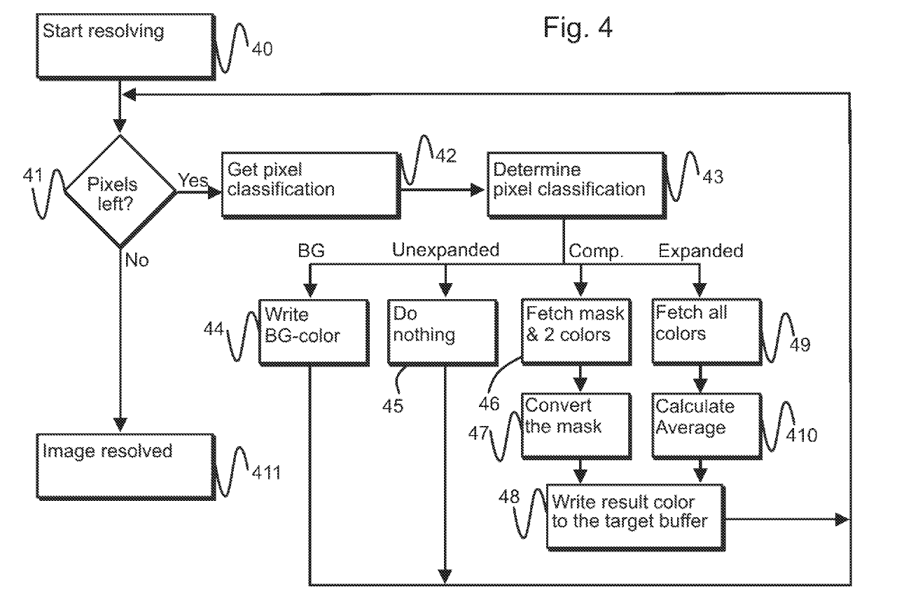

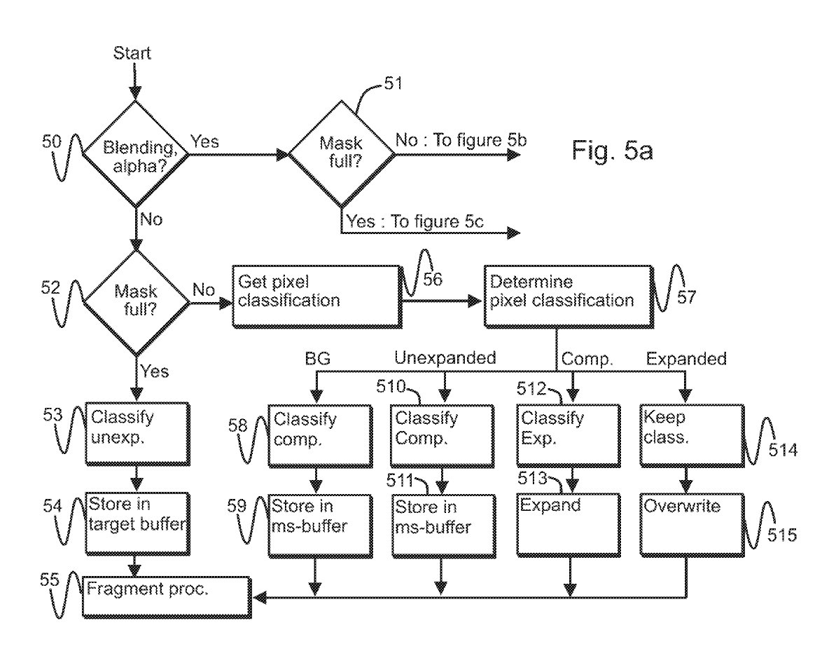

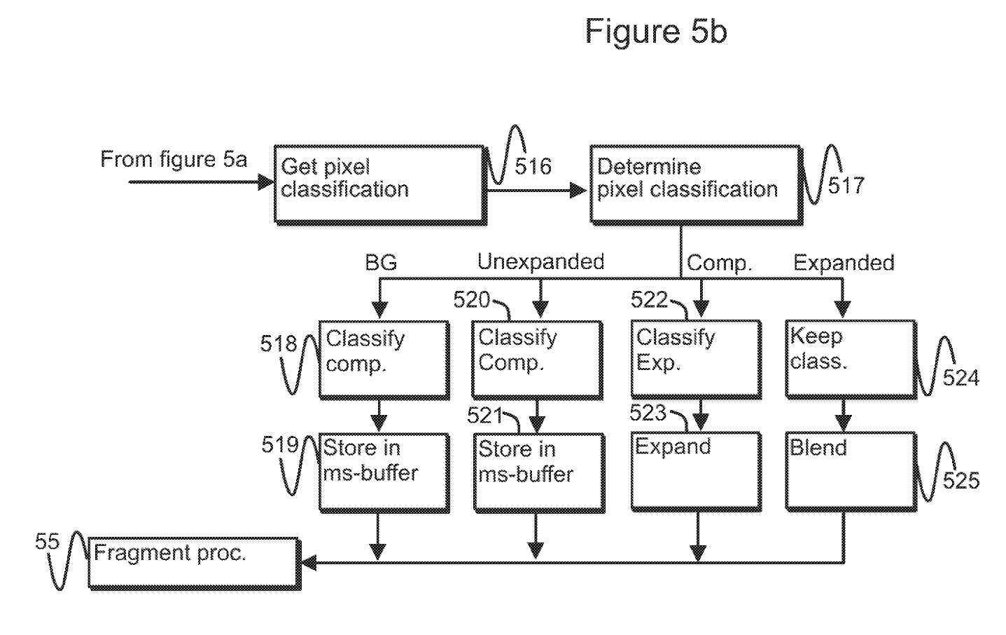

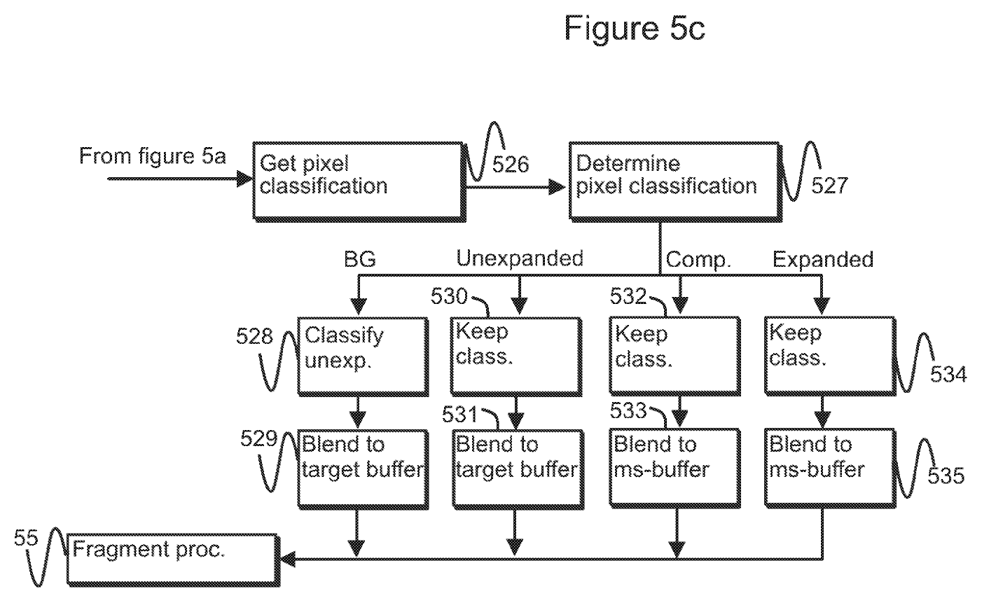

FIG. 3 discloses a flow chart of a further embodiment according to the present invention. In the present embodiment, the processing starts with a set of polygons to be rendered, step 30. First, a clearing procedure is performed, step 31. This involves only marking all pixels in the classification buffer as background pixels and storing the background color value. No pixel colors are modified in the target image buffer or the multi-sample buffer. Then the polygons are processed one by one, step 32. If there are polygons left, the data for the next polygon to be processed will be retrieved, step 33. The polygon data comprises, for example, the shape, paint and blend of the polygon. Then each pixel of the polygon is processed, step 34. If there are further pixels, a fragment, which is a coverage mask for one pixel, will be generated in step 35. The fragment is then processed, step 36, as shown in FIG. 5. If all pixels have been processed, the loop returns to step 32. If all polygons have been processed, the embodiment proceeds to resolving, step 37, as shown in FIG. 4. After resolving, the image is finished and the processing of the next image can be started.

FIG. 4 discloses a flow chart of an exemplary resolving process according to the present invention. Resolving according to the present invention proceeds pixel by pixel, step 40. However, a person having ordinary skill in the art recognizes that the functionality according to the present invention may be implemented in a device that is capable of processing a plurality of pixels at once. In that case it would be possible, for example, to process four or eight pixels at once and then proceed to the next set of pixels. The first step involves determining if there are further pixels left, step 41. If there are pixels left for resolving, the process will retrieve the pixel classification information, step 42, and then check how the pixel is classified, step 43. If the pixel is classified as background, the process will write background color to the target image buffer, step 44. If the pixel is classified as unexpanded, the process will do nothing as the data is already there, step 45. If the pixel is classified as compressed, the process will fetch the mask and two colors from the multi-sample buffer, step 46, convert the mask to alpha, and blend it together with the color values, step 47. Then the result is written to the target image buffer, step 48. If the pixel is classified as expanded, the resolving process will fetch all 16 color values from the multi-sample buffer, step 49, and calculate the averages of all 16 color values, step 410. Then the result color is written to the target image buffer. At this stage, the pixel is ready and the process continues with the next pixel. If there are no further pixels left, the image is resolved, step 411.

FIGS. 5a-5c disclose a flowchart of an embodiment for processing a fragment according to the present invention. The processing starts from FIG. 5a by checking if there is blending or alpha in the current pixel, step 50. If yes, the process will proceed by checking if the mask is full, step 51. If the mask is full, the processing will continue in FIG. 5c. If the mask is not full, the processing will continue in FIG. 5b. These figures are described in more detail later.

If there is no blending or alpha in the current pixel, the process will also check if the mask is full, step 52. If the mask is full, the pixel will be classified as unexpanded, step 53. Then the paint color is stored in the target image buffer, step 54. The processing of the current fragment is now ready, step 55.

If the mask is not full in step 52, the processing will first retrieve the pixel classification, step 56 and then determine the class, step 57. If the pixel is classified as background, the pixel will be classified as compressed, step 58. Then the mask, background and paint color are stored in the multi-sample buffer, step 59. If the pixel is classified as unexpanded, the pixel will be classified as compressed, step 510. Then the mask, the color from the target image buffer and the paint color are stored in the multi-sample buffer, step 511. If the pixel is classified as compressed, then the pixel will be classified as expanded, step 512. Then the compressed data in the multi-sample buffer is expanded, and the samples marked in the mask with paint color are overwritten, step 513. If the pixel is classified as expanded, then the classification will not be changed, step 514. Then the samples marked in the mask with paint color are overwritten in the multi-sample buffer, step 515. The fragment is now ready, step 55.

FIG. 5b discloses an example of processing continued from step 51 of FIG. 5a, in the case where the mask was not full. Now, the processing first retrieves the pixel classification, step 516, and then determines the class, step 517. If the pixel is classified as background, then the pixel will be classified as compressed, step 518. Then the mask, the background color and the background blended with paint color are stored in the multi-sample buffer, step 519. If the pixel is classified as unexpanded, then the pixel will be classified as compressed, step 520. Then the mask, the color from the target image buffer and the color from the target image buffer blended with the paint color will be stored in the multi-sample buffer, step 521. If the pixel is classified as compressed, then the pixel will be classified as expanded, step 522. Then the compressed data in the multi-sample buffer will be expanded and the paint color blended with the samples marked in the mask, step 523. If the pixel is classified as expanded, then the pixel classification will be maintained, step 524, and the paint color blended with the samples marked in the mask in the multi-sample buffer, step 525. The fragment is now ready, step 55.

FIG. 5c discloses an example of processing continued from step 51 of FIG. 5a, in the case where the mask was full. The processing procedure first retrieves the pixel classification, step 526, and then determines the class, step 527. If the pixel is classified as background, then the pixel will be classified as unexpanded, step 528, and paint color blended with background and stored in the target image buffer, step 529. If the pixel is classified as unexpanded, the classification will not be changed, step 530, and the paint color will be blended with the target image buffer, step 531. If the pixel is classified as compressed, the classification will not be changed, step 532, and the paint color will be blended with two compressed color values in the multi-sample buffer, step 533. If the pixel is classified as expanded, the classification will not be changed, step 534, and the paint color will be blended with all samples in the multi-sample buffer, step 535. The fragment is now ready, step 55.

As will be appreciated by one of ordinary skill in the art, the embodiments described herein are applicable to any suitable computing devices and systems that may employ process vector graphics including, but not limited to, wireless hand held devices, laptops, desk top computers, printers, servers, set top boxes, digital televisions, etc. Further changes may be made in the above-described method and device without departing from the true spirit and scope of the invention herein involved. It is intended, therefore, that the subject matter in the above disclosure should be interpreted as illustrative, not in a limiting sense.

It is obvious to a person skilled in the art that with the advancement of technology, the basic idea of the invention may be implemented in various ways. The invention and its embodiments are thus not limited to the examples described above; instead they may vary within the scope of the claims.

1. A method for rendering a vector graphics image, comprising:
resolving pixel values based upon a pixel classification and coverage value associated with each pixel; and
producing an image in a buffer using said resolved pixel values.

2. The method of claim 1, further comprising:
determining a pixel classification and coverage value for each pixel.

3. The method according to claim 2, wherein the pixel classification comprises a background class.

4. The method according to claim 3, wherein the pixel classification further comprises unexpanded, compressed and expanded classes.

5. The method according to claim 4, wherein, in the compressed class, the coverage mask of the pixel is compressed using a lossless compression method.

6. The method according to claim 3, wherein the method further comprises clearing a portion of the memory comprising the pixel classification information buffer by setting all pixels in said portion as background.

7. The method according to claim 2, wherein said vector graphics image is rendered in tiles.

8. The method according to claim 2, wherein said rendering further comprises intermediate resolving during rendering.

9. The method according to claim 2, wherein the method further comprises converting the classification.

10. A graphics device, comprising:
memory configured to store at least a classification buffer, a multi-sample buffer and a target image buffer; and
a processor, wherein
said processor is configured to produce an image in the target image buffer by using said classification buffer and said multi-sample buffer for the pixel classification, wherein said image is produced based on the coverage value and classification of each pixel.

11. The graphics device according to claim 10, wherein said processor is configured to classify pixels into classes, comprising a background class.

12. The graphics device according to claim 11, wherein said processor is further configured to classify pixels into classes comprising unexpanded, compressed and expanded classes.

13. The graphics device according to claim 12, wherein said processor is further configured to compress in said compressed class the coverage mask of the pixel using a lossless compression method.

14. The graphics device according to claim 11, wherein said processor is configured to clear said classification buffer by setting all pixels in said classification buffer as background.

15. The graphics device according to claim 10, wherein said processor is configured to resolve pixel values using said classification and multi-sample buffers.

16. The graphics device according to claim 10, wherein said processor is further configured to render a vector graphics image in tiles.

17. The graphics device according to claim 10, wherein said processor is configured to perform intermediate resolving during rendering.

18. The graphics device according to claim 10, wherein the rendering block is coupled to an additional memory.

19. A graphics processor for processing vector graphics, comprising:
a memory configured to store at least a classification buffer, a multi-sample buffer and a target image buffer; and
processing means, wherein said processing means are configured to produce an image in the target image buffer by using said classification buffer and said multi-sample buffer for the pixel classification, wherein said image is produced based on the coverage value and classification of each pixel.
